(19) United States
(12) Patent Application Publication
(10) Pub. No.: US 2007/0058034 A1
(43) Pub. Date: Mar. 15, 2007

(54) Stereoscopic image display device, stereoscopic display program, and stereoscopic display method

(76) Inventors: Shunichi Numazaki, Kanagawa (JP); Tatsuo Saishu, Tokyo (JP); Rieko Fukushima, Tokyo (JP); Yuzo Hirayama, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/518,994

(22) Filed: Sep. 12, 2006

(30) Foreign Application Priority Data
Sep. 12, 2005 (JP) P2005-264176

(51) Int. Cl. H04N 13/04

(52) U.S. Cl. 348/51

(57) ABSTRACT

A stereoscopic image display device includes a stereoscopic image display unit that displays a stereoscopic image. The stereoscopic image display unit includes: an image display element that is arranged with a plurality of color pixels; and a beam direction limitation element that is provided on the image display element and limits a direction of a beam exiting from the image display element. The stereoscopic image display device further includes: a movement command reception unit that receives a command to move the stereoscopic image displayed on the stereoscopic image display unit to a movement position; and a display position correction unit that corrects the movement position that is determined by the command received by the movement command reception unit, to a position where color information of the stereoscopic image remains uncollapsed.

### RELATED APPLICATION(S)

The present disclosure relates to the subject matter contained in Japanese Patent Application No. 2005-264176 filed on Sep. 12, 2005, which is incorporated herein by reference in its entirety.

### FIELD

The present invention relates to a stereoscopic image display device, and a method and program product for displaying stereoscopic image.

### BACKGROUND

Stereoscopic image display devices of various types have recently been developed and put into practice. For example, the principle of a stereoscopic image display device of integral imaging type using a perpendicular lenticular lens is described in detail in JP-A-2005-086414, the corresponding U.S. patent publication number thereof is: US2005083246.

In the stereoscopic image display device of integral imaging type using such a perpendicular lenticular lens, 18 sub-pixels (i.e., six pixels) are provided within, e.g., one pitch of the lens, and beams emitted from the 18 sub-pixels are distributed into 18 directions in an observation space by means of a lens. Display of the thus-separated beams by all the lenses makes feasible a stereoscopic image display device that enables observation of an image that varies according to the position of the observer's eyes. Such a stereoscopic image display device of integral imaging type is characterized in that the color filter of this stereoscopic image display device differs in configuration from that of an ordinary stereoscopic device. In the stereoscopic image display device of integral imaging type, color filters are vertically arranged in color sequence of RBGRBG . . . By virtue of such a color arrangement, one color is formed from three vertically-arranged sub-pixels. The three vertically-arranged sub-pixels are arranged in the number of 18 within one lens pitch, to thus realize 18 parallaxes. When the configuration of an ordinary color filter is used, a single color must be expressed by three horizontally-arranged sub-pixels. As a result, only six parallaxes can be achieved. For this reason, adoption of the above configuration is very effective.

Conventionally, at the time of display of a stereoscopic image, a stereoscopic display is, in most cases, provided on the entire display of the stereoscopic image display device. However, when a stereoscopic content, which is lower in display resolution than a screen, is displayed in a part of the screen as in the case of a window which is a graphical user interface of the OS (Operating System) of a personal computer, the stereoscopic image display device of integral imaging type encounters problems to be solved.

As mentioned previously, in the stereoscopic image display device of integral imaging type, color filters are arranged vertically in color sequence of RBGRBG . . . , whereby three vertically-arranged sub-pixels constitute a single color. In the event of an image to be displayed having been offset by one or two pixels in the vertical direction, the combination of RGB gets out of sequence, which in turn changes the color of the image. Namely, when a stereoscopic content, which is lower in resolution than the display, is displayed on the stereoscopic image display device of integral imaging type, there may arise a problem of failure to display a proper color image for the location where the content is arranged.

The stereoscopic image display device of integral imaging type displays some pixels or some sets of sub-pixels separately in a given direction. Hence, when the stereoscopic image is moved, the manner of viewing the stereoscopic image becomes improper without consideration of the unit of the set of pixels or sub-pixels.

Stereoscopic display using a tilted lenticular lens is also available. In this case, color information is maintained, but the direction of a viewing zone is changed as a result of the stereoscopic image being moved. It is difficult to move the stereoscopic image without changing the direction of the viewing zone.

### SUMMARY

According to a first aspect of the invention, there is provided a stereoscopic image display device including: a stereoscopic image display unit that displays a stereoscopic image, and includes: an image display element that is arranged with a plurality of color pixels; and a beam direction limitation element that is provided on the image display element and limits a direction of a beam exiting from the image display element; a movement command reception unit that receives a command to move the stereoscopic image displayed on the stereoscopic image display unit to a movement position; and a display position correction unit that corrects the movement position that is determined by the command received by the movement command reception unit, to a position where color information of the stereoscopic image remains uncollapsed.

According to a second aspect of the invention, there is provided a stereoscopic image display device including: a stereoscopic image display unit that displays a stereoscopic image, and includes: an image display element that is arranged with a plurality of color pixels; and a beam direction limitation element that is provided on the image display element and limits a direction of a beam exiting from the image display element; a movement command reception unit that receives a command to move the stereoscopic image displayed on the stereoscopic image display unit; and a viewing zone direction correction unit that corrects the movement position of the stereoscopic image determined by the command received by the movement command reception unit, to a position where the direction of a viewing zone of the stereoscopic image remains unchanged.

According to a third aspect of the invention, there is provided a computer-readable program product for causing a computer to control a stereoscopic display device to display a stereoscopic image, the stereoscopic display having a stereoscopic image display unit that displays the stereoscopic image, and includes: an image display element that is arranged with a plurality of color pixels; and a beam direction limitation element that is provided on the image display element and limits a direction of a beam exiting from the image display element. The program product causes the computer to perform procedures including: receiving a command to move the stereoscopic image displayed on the stereoscopic image display unit to a movement position; and correcting the movement position that is determined by the received command, to a position where color information of the stereoscopic image remains uncollapsed.

According to a fourth aspect of the invention, there is provided a computer-readable program product for causing a computer to control a stereoscopic display device to display a stereoscopic image, the stereoscopic display having a stereoscopic image display unit that displays the stereoscopic image, and includes: an image display element that is arranged with a plurality of color pixels; and a beam direction limitation element that is provided on the image display element and limits a direction of a beam exiting from the image display element. The program product causes the computer to perform procedures including: receiving a command to move the stereoscopic image displayed on the stereoscopic image display unit to a movement position; correcting the movement position that is determined by the received command, to a position where color information of the stereoscopic image remains uncollapsed; and correcting the movement position of the stereoscopic image determined by the received command, to a position where the direction of a viewing zone of the stereoscopic image remains unchanged.

According to a fifth aspect of the invention, there is provided a method for controlling a stereoscopic display device to display a stereoscopic image, the stereoscopic display having a stereoscopic image display unit that displays the stereoscopic image, and includes: an image display element that is arranged with a plurality of color pixels; and a beam direction limitation element that is provided on the image display element and limits a direction of a beam exiting from the image display element. The method includes: receiving a command to move the stereoscopic image displayed on the stereoscopic image display unit to a movement position; and correcting the movement position that is determined by the received command, to a position where color information of the stereoscopic image remains uncollapsed.

According to a sixth aspect of the invention, there is provided a method for controlling a stereoscopic display device to display a stereoscopic image, the stereoscopic display having a stereoscopic image display unit that displays the stereoscopic image, and includes: an image display element that is arranged with a plurality of color pixels; and a beam direction limitation element that is provided on the image display element and limits a direction of a beam exiting from the image display element. The method includes: receiving a command to move the stereoscopic image displayed on the stereoscopic image display unit to a movement position; correcting the movement position that is determined by the received command, to a position where color information of the stereoscopic image remains uncollapsed; and correcting the movement position of the stereoscopic image determined by the received command, to a position where the direction of a viewing zone of the stereoscopic image remains unchanged.

### BRIEF DESCRIPTION OF THE DRAWINGS

In the accompanying drawings:

FIG. 1 is a block diagram showing a configuration of a stereoscopic image display device according to a first embodiment;

FIG. 2 is a block diagram showing a functional configuration of the stereoscopic image display device;

FIG. 3 is a perspective view showing a configuration of the stereoscopic image display unit in a partially-enlarged manner;

FIG. 4 is a plan view showing an example pixel arrangement;

FIG. 5 is a flowchart showing a flow of processing for correcting a display position of the stereoscopic image;

FIG. 6 is a descriptive view showing a direction of a standard viewing zone on a stereoscopic image display unit of integral imaging type which is a premise of a second embodiment;

FIG. 7 is a descriptive view showing changes in the direction of viewing zone achieved when the display position has become displaced by only a first shift pitch;

FIG. 8 is a descriptive view showing two viewing zone directions which are simultaneously observed;

FIG. 9 is a block diagram showing a functional configuration of a stereoscopic image display device according to the second embodiment; and

FIG. 10 is a flowchart showing the flow of processing for optimizing the direction of the viewing zone.

### DETAILED DESCRIPTION OF THE EMBODIMENTS

First Embodiment

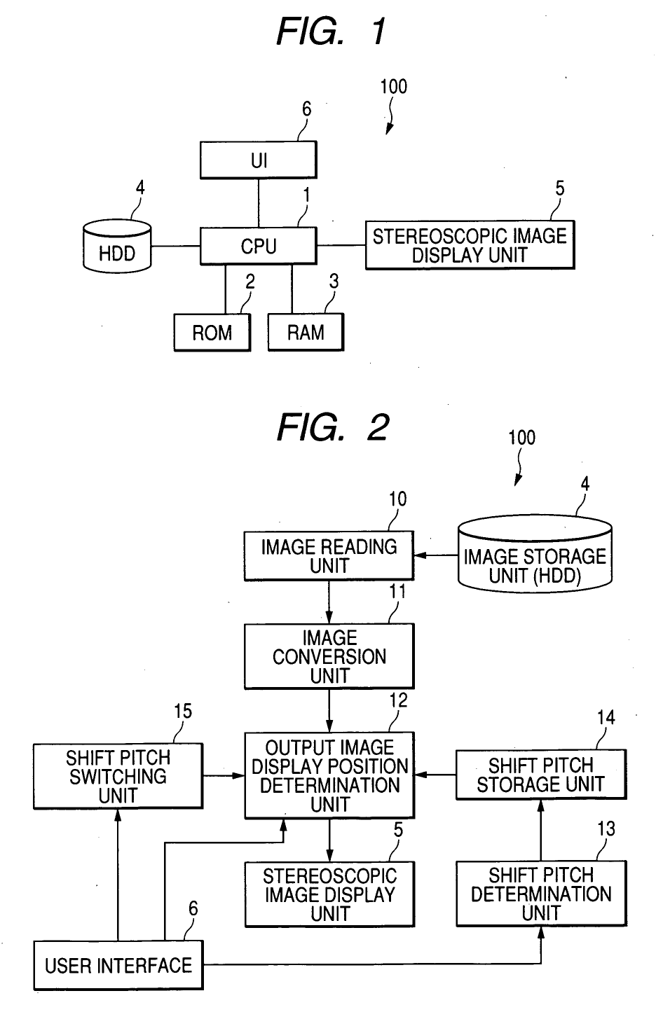

A first embodiment according to the present invention will be described by reference to FIGS. 1-4.

FIG. 1 is a block diagram showing a configuration of a stereoscopic image display device 100 according to a first embodiment. The stereoscopic display device 100 includes a CPU (Central Processing Unit) 1 which performs information processing; ROM (Read-Only Memory) 2 which is read-only memory where a BIOS, or the like, is stored; RAM (Random Access Memory) 3 which is a storage section for storing various sets of data in a rewritable manner; an HDD (Hard Disk Drive) 4 which serves as image storage unit for storing a stereoscopic content and stores a stereoscopic image display program; a stereoscopic image display unit 5 of integral imaging type which outputs and displays a stereoscopic image; a user interface 6 by means of which the user inputs various commands to the device or displays various types of information, and the like.

The CPU 1 of the stereoscopic image display device 100 performs various arithmetic operations in accordance with a stereoscopic display program, to thus control individual sections. There will now be described characteristic processing of the present embodiment which is performed by the CPU 1 of the stereoscopic image display device 100 according to the stereoscopic display program.

FIG. 2 is a block diagram showing the functional configuration of the stereoscopic image display device 100. As shown in FIG. 2, the stereoscopic image display device 100 includes an image reading unit 10 which reads a stereoscopic content stored in the image storage unit (the HDD 4) as a result of the CPU 1 controlling individual units according to the stereoscopic display program; an image conversion unit 11 for converting the image read by the image reading unit 10 into an appropriate image output to the stereoscopic image display unit 5; an output image display position determination unit 12 which appropriately controls and determines the display position of the image output to the stereoscopic image display unit 5; a shift pitch determination unit 13 which determines a shift pitch suitable for the currently-connected stereoscopic image display unit 5; a shift pitch storage unit 14 for storing the shift pitch determinedly the shift pitch determination unit 13 into the RAM 3; and a shift pitch switching unit 15 switching between a state where any of the plurality of shift pitches stored in the RAM 3 is used and a state where none of the plurality of shift pitches are used.

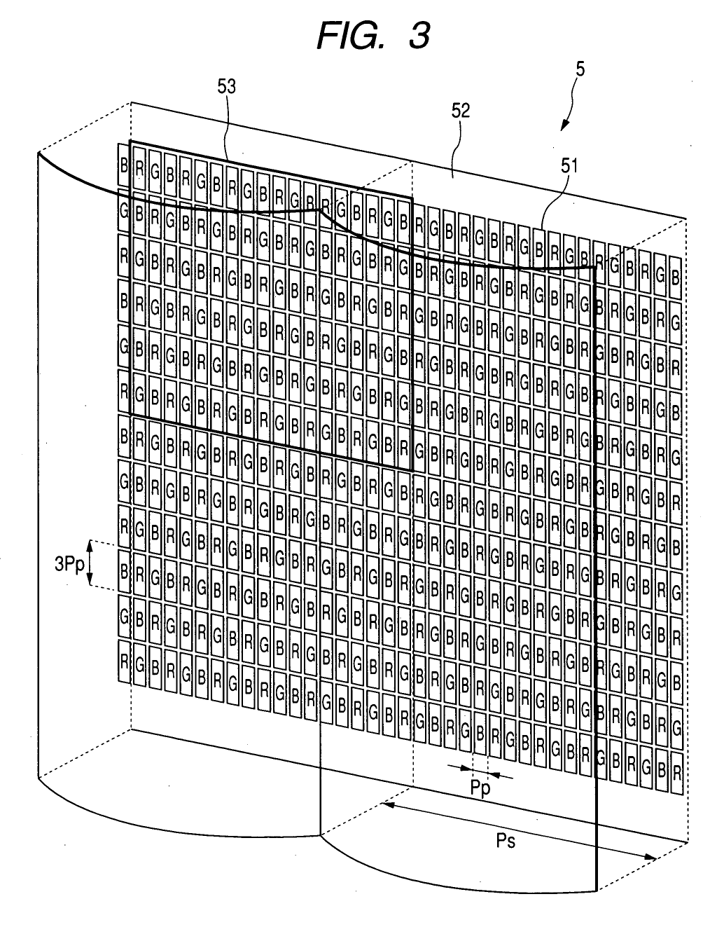

The stereoscopic image display unit 5 will now be described. FIG. 3 is a perspective view showing the configuration of the stereoscopic image display unit 5 in a partially-enlarged manner. As shown in FIG. 3, the stereoscopic image display unit 5 includes an image display element 51 which has a plurality of color pixels arranged in a two-dimensional plane and can display a color image; and a beam direction limitation element 52 which limits the direction of a beam exiting from the color pixel, to thus restrict a horizontally-viewable angle. In relation to the image display element 51, a positional deviation of the color pixel within the screen greatly affects the outgoing direction of the beam. Hence, a so-called flat panel—where pixels are two-dimensionally arranged in a matrix pattern—is more preferable than a CRT or a projector. Display types for such a flat panel include a non-luminous liquid-crystal panel (LCD), a luminous plasma display panel (PDP), an organic EL (electroluminescence) panel, and the like. The beam direction limitation element 52 is a perpendicular lenticular lens having a generatrix in the direction perpendicular to the screen.

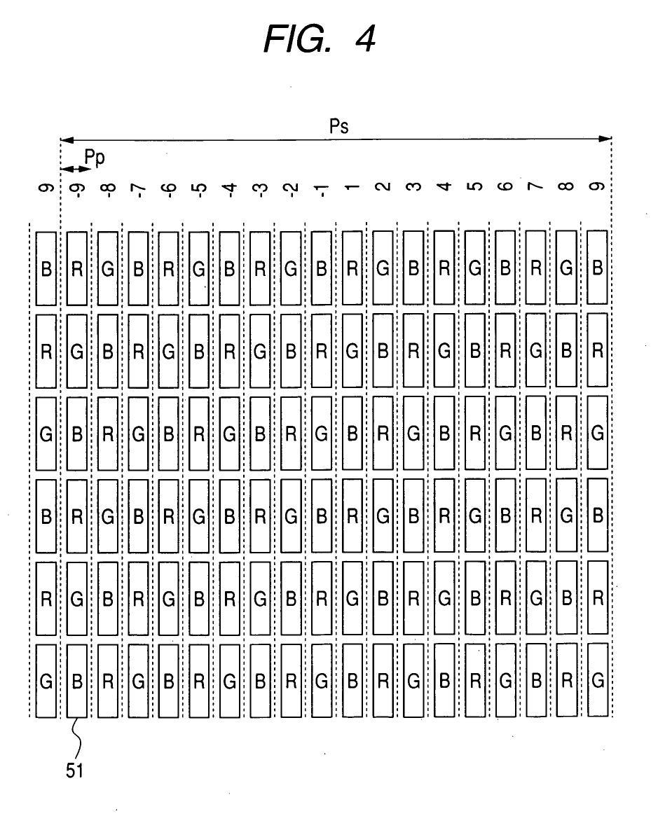

Pixels, each having an aspect ratio of 3:1, are linearly arranged in a matrix pattern on the image display element 51 in the lateral and longitudinal directions. The pixels are arranged horizontally in repeating sequence of R (red), G (green), and B (blue) within a single row, and the pixels are arranged vertically in repeating sequence of R (red), B (blue), and G (green) within a single column. FIG. 4 is a plan view showing an example pixel arrangement. Numerals from −9 to 9 designate parallax numbers. Adjacent parallax numbers are assigned to adjacent columns. The longitudinal cycle of pixel rows is triple a lateral cycle Pp of pixels. In the image display element 51 shown in FIG. 3, one effective pixel 53 (indicated by a black frame shown in FIG. 3) consists of 6 rows by 18 columns of pixels. By means of the structure of such an image display element 51, a stereoscopic display which imparts 18 parallaxes in the horizontal direction can be provided.

In the image output to such a stereoscopic image display unit 5, parallax images are interleaved. Hence, when the stereoscopic image is observed without use of the beam direction limitation element (perpendicular lenticular lens) 52, the image is not recognized as a normal image. Accordingly, this image is not suitable for image compression such as JPEG or MPEG. An image into which the respective parallax images are arranged in an array is stored in the image storage unit (the HDD 4) in a compressed manner. During playback, the image conversion unit 11 performs interleaving conversion with a view toward decoding the image read by the image reading unit 10 to thus reconstruct an image; and conversion of the image into an image which can be output to the stereoscopic image display unit 5. Before subjecting the decoded image to interleaving conversion, the image conversion unit 11 can change the size of the image by means of scaling up or down the image. The reason for this is that interleaving conversion can be carried out properly even when the size of the decoded image has been changed.

However, in the image display element 51 of the stereoscopic image display unit 5 of integral imaging type, the color filters are vertically arranged in color sequence of RBGRBG . . . , whereby a single color is made from three vertically-arranged sub-pixels. Therefore, when an image to be displayed is vertically offset by one or two pixels, the combination of RGB is misaligned, so that the color of the image is changed. Specifically, when the stereoscopic image display unit 5 of integral imaging type displays a stereoscopic content whose resolution is lower than the resolution of the display, there may arise a problem of failure to display a proper color image depending on a location where the content is to be arranged.

In the present embodiment, the shift pitch determination unit 13 determines a shift pitch suitable for the currently-connected stereoscopic image display unit 5. The shift pitch determined by the shift pitch determination unit 13 is stored in the RAM 3 by means of the shift pitch storage unit 14. The shift pitch switching unit 15 performs switching between using any one of the plurality of shift pitches stored in the RAM 3 and using none of them. The output image display position determination unit 12 appropriately controls and determines an output image display position of the stereoscopic image display unit 5, by reference to the shift pitch switched by the shift pitch switching unit 15. In this regard, detailed descriptions are provided below.

It is assumed that the shift pitch has a different value according to the type of the stereoscopic image display unit 5, and the shift pitches for respective types are stored in the RAM 3 by the shift pitch storage unit 14. The shift pitch determination unit 13 determines the shift pitch from the attribute information about the stereoscopic image display unit 5. The manner of determination can also be implemented by means of storing, as a table, combinations of types of the stereoscopic image display units 5 with shift pitches and making reference to the table to thus determine a shift pitch; or computing a shift pitch from the inclination of the beam direction limitation element (the perpendicular lenticular lens) 52 and the number of parallaxes. The user can also control the shift pitch determination unit 13 by means of specifying the type of the stereoscopic image display unit 5 by way of the user interface 6. Alternatively, amounts of shift pitches are stored in advance in the stereoscopic image display unit 5, and any of the shift pitches can also be read and stored.

When the image having undergone interleaving conversion is output to the stereoscopic image display unit 5, the image is output to the output image display position determined by the output image display position determination unit 12. When the user has made alterations to the output image position, the output image display position determination unit 12 makes changes to thus display the image at an appropriate position closest to the desired position to which the output image display position is to be changed.

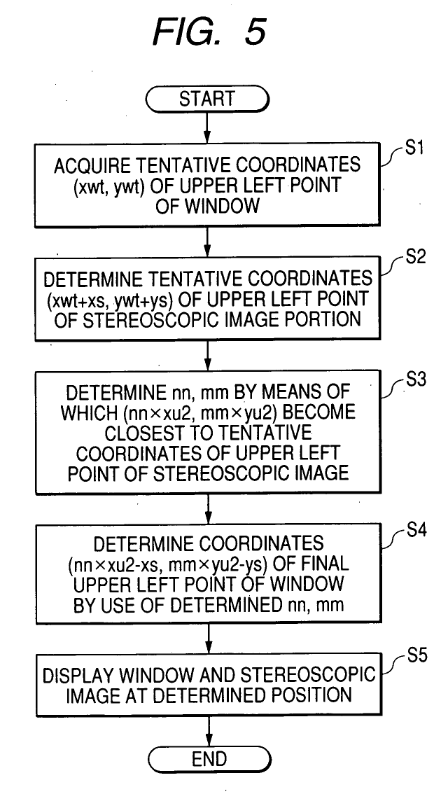

The technique of the output image display position determination unit 12 correcting the output image display position when the user has changed the position of an output image will be described by reference to the flowchart shown in FIG. 5. The shift pitch storage unit 14 stores, in the RAM 3, a first shift pitch (xu1, yu1) that is the minimum shift pitch by means of which the direction of a viewing zone of a stereoscopic image remains unchanged, and a second shift pitch (xu2, yu2) that is the minimum shift pitch by means of which color information about a stereoscopic image remains uncollapsed. In the present embodiment, the position of the output image is adjusted by reference to the second shift pitch (xu2, yu2).

For example, in a conceivable case where the display of a stereoscopic image is processed by the OS, the contents of a window—a graphical user interface of the OS—are assumed to be a stereoscopic image, and the window is assumed to be moved. In general, when a window is displayed, coordinates (xw, yw) of the upper left position of the window are specified and displayed. Specifically, a stereoscopic image in the window is displayed while being displaced to a given position (xs, ys) from the upper left end of the window. Therefore, the coordinates of the upper left position assume (xw+xs, yw+ys). The output image display position determination unit 12 is adjusted such that the position (xw+xs, yw+ys) becomes appropriate.

As shown in FIG. 5, when the user has acquired tentative coordinates (xwt, ywt) of the upper left position of the window, which are determined as a result of the user having moved the window (step S1), tentative upper left coordinates (xwt+xs, ywt+ys) of the stereoscopic image display in the window are determined (step S2).

In subsequent step S3, nn and mm—by means of which (nn×xu2, mm×yu2) becomes closest to the tentative upper left coordinates (xwt+xs, ywt+ys) of the stereoscopic image—are determined. More specifically, there are present integers “n” and “m” which satisfy the following equations.
n×xu2<xwt+xs<(n+1)×xu2
m×yu2<ywt+ys<(m+1)×yu2

At this time, when the following equation is satisfied, it is assumed that nn=n, otherwise, it is assumed that nn=n+1.
(xwt+xs)−(n×xu2)<[(n+1)×xu2]−(xwt+xs)

Provided that the following equation is satisfied, it is assumed that mm=m, otherwise it is assumed that mm=m+1.
(ywt+ys)−(m×yu2)<[(m+1)×yu2]−(vwt+vs)

Specifically, this expression shows that an integer “n” where “n×xu2” becomes closest to “xwt+xs” is “nn”; and that an integer “m” where “m×yu2” becomes closest to “ywt+ys” is “mm”.

Subsequently, the final coordinates of the upper left position of the window (nn×xu2−xs, mm×yu2−ys) are determined through use of the thus-determined “nn” and “mm” (step S4). A window and a stereoscopic image are displayed in the thus-determined position (step S5). In more detail, the adjusted position of the window (xw, yw) is determined from the following equations.
xw=nn×xu2−xs
yw=mm×yu2−ys,

And the window is displayed in accordance with the coordinates. The stereoscopic portion in the window is appropriately displayed.

As mentioned above, according to the present embodiment, when the command to move the stereoscopic image displayed in the stereoscopic image display unit has been received, the movement position of the stereoscopic image determined by the received movement command is corrected to a position where color information about the stereoscopic image remains uncollapsed. As a result, even when the manner of viewing the stereoscopic image becomes unnatural when the stereoscopic image is moved without consideration of the unit of the sets of pixels or the sets of sub-pixels as in the case of the stereoscopic image display device of integral imaging type, occurrence of a phenomenon of the image failing to be viewed as a proper stereoscopic image can be avoided. Even when the stereoscopic image is moved in accordance with the movement command, the stereoscopic image can be controlled such that an appropriate stereoscopic image is displayed.

When the stereoscopic image is displayed in the window, which is the graphical user interface of the OS, both moving the window itself and moving only the stereoscopic image in the window without movement of the window can be implemented.

Second Embodiment

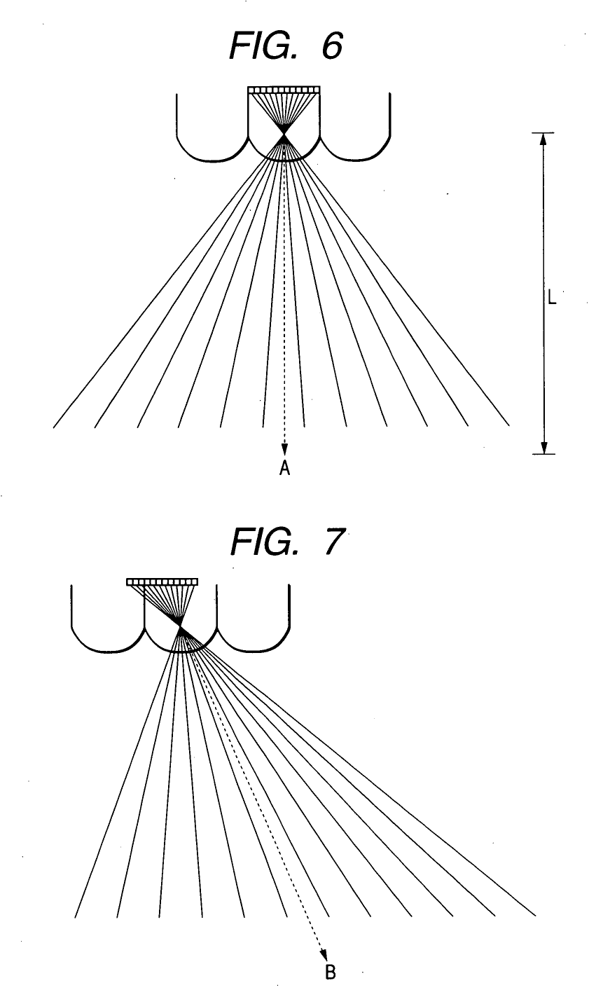

A second embodiment will now be described by reference to FIGS. 6-10. Those elements which are the same as those described in connection with the first embodiment are assigned the same reference numerals, and repeated explanations are omitted.

In the first embodiment, even when the window—the graphical user interface of the OS—has been moved, the direction of the viewing zone is maintained at all times. However, there may arise a case where the ease of use can be enhanced by means of a contrivance to control the direction of the viewing zone toward the observer at all times. For example, in a case where the screen size is large and the window is comparatively smaller, there may arise a case where the position of the observer moves to or beyond the edge of the viewing zone as a result of the window being moved to the edge thereof. Even when the width of the viewing zone is originally designed so as to be narrow as a characteristic of the stereoscopic image display unit 5, the same problem may arise.

FIG. 6 shows how 12 sub-pixels of one element image in the stereoscopic image display unit of 12-parallax integral imaging type using a perpendicular lenticular lens are reproduced in a space by the lens. Here, the image is presumed to be displaced by one pixel. One pixel corresponds to three sub-pixels. Hence, reproduction of beams from the 12 sub-pixels in the element image changes as shown in FIG. 7. The center direction of the viewing zone is also changed from A to B. The amount of displacement is determined as “L×3×tanθ” in accordance with the observation distance “L”. Here, “tanθ” is a factor representing one interval between breams and unique to each stereoscopic image display unit. Accurately, “s”-numbers of sub-pixels exist in one element image. When the sub-pixels are assigned to angles of ±θ1 by means of the lens, tano is expressed by the following expression.
tan θ=2×tan θ1÷s

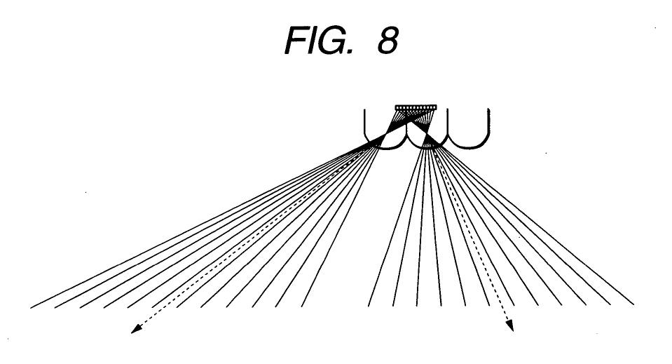

When the window—the graphical user interface of the OS—has been moved, the direction of the viewing zone can be adjusted in such a way that the center of the viewing zone of the stereoscopic display image in the window passes through a position closest to the observation position. Here, the center of the viewing zone is assumed to be the center of the reproduction direction of a beam at the center of the stereoscopic image. First, when the “x” coordinate of a certain element image is “a×xu1+b×xu2,” consideration is given to the orientation of the center of the reproduction direction of the beam. In the case of the 12-parallax stereoscopic display unit, the width of one element image is equal to four pixels (i.e., 12 sub-pixels). Here, reference symbol “a” assumes a value falling within the range of −3 to +3. In relation to the respective values of “a,” a displacement from the center of the viewing zone at the observation distance L is defined as “−a×L×3×tan θ.” The displacement of the visual range is assumed to be positive when the displacement is oriented in the same direction as that of the “x” coordinate on the screen. However, For example, in the case of “a=−1”, the image is displaced to a position of “L×3×tan θ.” Incidentally, the same point can be observed at a position of “−3×L×3×tan θ” (see FIG. 8), as well. This is the same as a case where the same point can be repeatedly observed at a position of “±12×L×tan θ” during ordinary observation of a stereoscopic image.

In the present embodiment, when the user has moved the position of the window—a graphical user interface of the OS—adjustment of the movement position conforming to the minimum shift pitch at which the direction of the viewing zone remains unchanged is performed in addition to performing adjustment of the movement position conforming to the minimum shift pitch at which color information described in connection with the first embodiment remains uncollapsed. Thus, the direction of the viewing zone is directed toward the observer at all times.

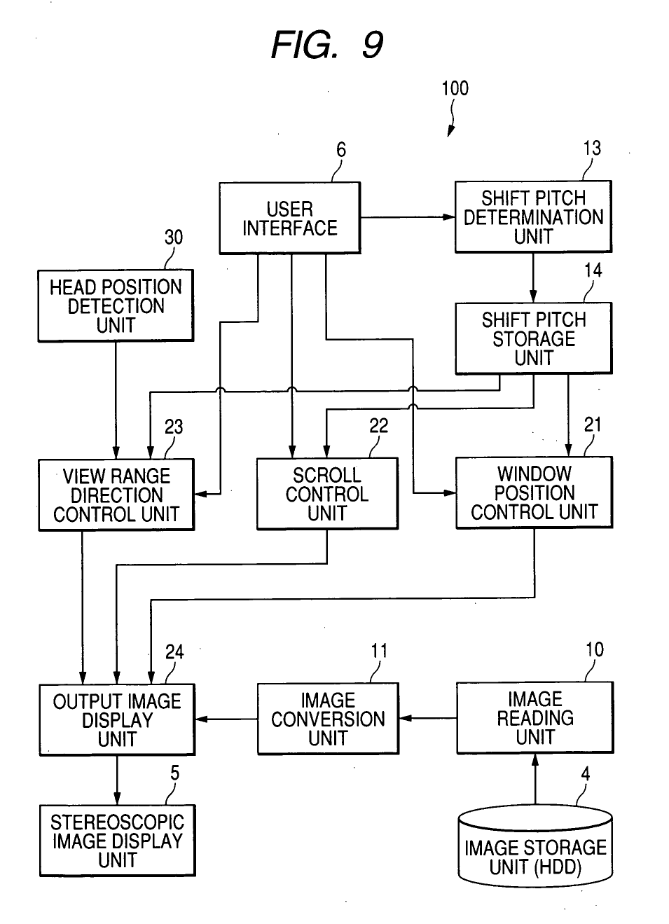

FIG. 9 is a block diagram showing the functional configuration of a stereoscopic image display device 100 according to a second embodiment. As shown in FIG. 9, the stereoscopic image display device 100 includes a plurality of display position control unit (window position control unit 21, scroll control unit 22, and a viewing zone direction control unit 23) which operate in conjunction with the shift pitch storage unit 14 and output image display unit 24, in addition to comprising the image reading unit 10 which reads a stereoscopic content stored in the image storage unit (the HDD 4) described in connection with the first embodiment, as a result of the CPU 1 controlling individual sections according to the stereoscopic display program; the image conversion unit 11 for appropriately converting the image read by the image reading unit 10 into an appropriate image output to the stereoscopic image display unit 5; the shift pitch determination unit 13 which determines a shift pitch suitable for the currently-connected stereoscopic image display unit 5; and the shift pitch storage unit 14 for storing the shift pitch determined by the shift pitch determination unit 13 into the RAM 3.

As the shift pitch stored in the RAM 3 by the shift pitch storage unit 14, the second shift pitch, which is the minimum shift pitch at which color information remains uncollapsed, and the first shift pitch, which is the minimum shift pitch at which the direction of the viewing zone remains unchanged, are provided for the respective types of stereoscopic image display unit 5.

The window position control unit 21 determines the shift pitch (the first shift pitch) suitable for the currently-connected stereoscopic image display unit 5 from the plurality of shift pitches stored in the RAM 3 by means of the shift pitch storage unit 14. The output image display position on the stereoscopic image display unit 5 is appropriately controlled and determined, and positional information is passed to the output image display unit 24.

The viewing zone direction control unit 23 detects the position of the observer's head by use of the head position detection unit 30 provided on the stereoscopic image display device 100, thereby determining the direction of a viewing zone suitable for that position. Positional information about the position is passed to the output image display unit 24. Although head position detection unit 30 is not described in detail, there can be used a method for attaching, e.g., an ultrasonic sensor to the observer's head and detecting the position of the head; a method for attaching a marker to the observer's head and detecting the position of the head through use of a camera image; or a method for detecting the position of the face from an image including an observer.

When a stereoscopic image is scrolled, the scroll control unit 22 determines a shift pitch (the second shift pitch) suitable for the currently-connected stereoscopic image display unit 5 among the plurality of shift pitches stored in the RAM 3 by the shift pitch storage unit 14; appropriately controls and determines the output image display position on the stereoscopic image display unit 5; and passes positional information to the output image display unit 24. For example, the right end and the left end are continuous with each other. In the case of a stereoscopic image whose upper and lower ends are continuous, an area—which cannot be displayed at the edge—is displayed on the opposite side by means of scrolling the image in a desired direction, so that endless scroll becomes possible. In the case of such scroll control operation, scrolling can be basically performed while the direction of the viewing zone is maintained by use of the shift pitch (the second shift pitch). If the viewing zone is desired to be controlled according to the position of the head while scrolling is being performed, the scroll position and the direction of the viewing zone can be controlled in conjunction with the viewing zone direction control unit 23.

The output image display unit 24 displays a stereoscopic image according to the positional information passed from the respective display position control unit (the window position control unit 21, the scroll control unit 22, and the viewing zone direction control unit 23) to thus enable appropriate control of the direction of the viewing zone.

Even when a stereoscopic image is displayed on the overall screen, there may be a case where the direction of the viewing zone is desired to be controlled. In such a case, the direction of the viewing zone can be controlled by means of slightly adjusting a position in increments of the second shift pitch from the state where the stereoscopic image is displayed over the display device.

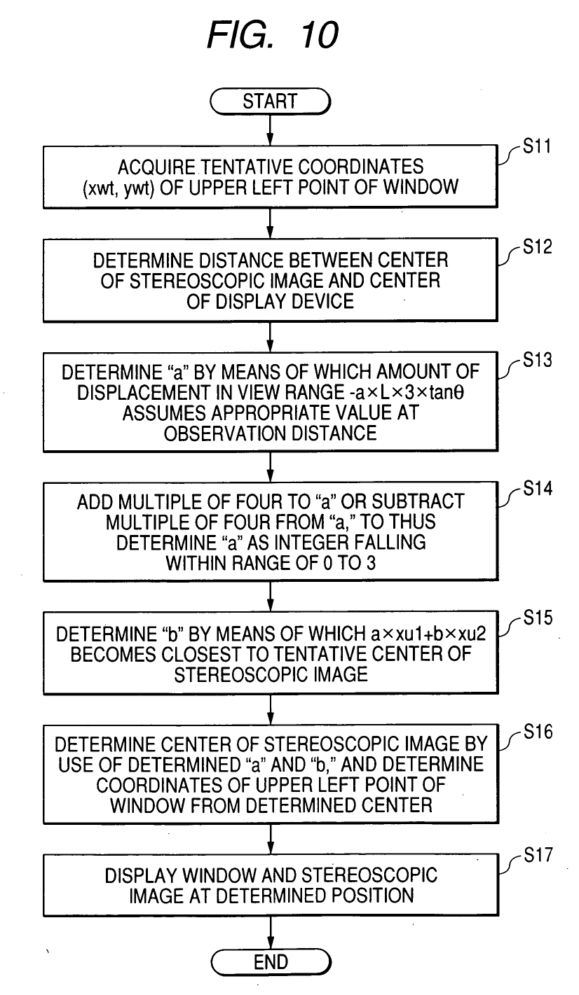

A method for optimizing the direction of the viewing zone when the user has changed the position of an output image will be described by reference to the flowchart shown in FIG. 10. In a case where a stereoscopic image is displayed on the OS, the contents of the window—the graphical user interface of the OS—are a stereoscopic image and that the window is moved. The position of the observer is assumed to be spaced from the center of the stereoscopic image display unit 5 by a distance L.

As shown in FIG. 10, when the user has acquired tentative coordinates (xwt, ywt) of the upper left point of the window, which are determined as a result of the user having moved the position of the window (step S11), a distance D between the center of the stereoscopic image and the center of the stereoscopic image display unit 5 (D is taken to be positive when the center of the stereoscopic image is displaced from the center of the stereoscopic image display unit 5 in the positive direction along the X axis) is sought (step S12). In short, the essential requirement is to displace the center of the viewing zone by D at the observation distance L.

In subsequent step S13, “a”—by means of which the amount of displacement of the viewing zone “−a×L×3×tan θ” assumes an appropriate value at the observation distance—is determined. Namely, there is determined “a” by means of which the amount of displacement of the viewing zone “−a×L×3×tan θ” becomes closest to the distance D between the center of the stereoscopic image and the center of the stereoscopic image display unit 5.

A multiple of four is added to or subtracted from “a,” to thus determine “a” as an integer falling within the range from 0 to 3 (step S14).

Subsequently, “b”—by means of which “a×xu1+b×xu2” becomes closest to the position of the tentative window at the center of the stereoscopic image—is determined (step S15).

In subsequent step S16, the center of the stereoscopic image, “a×xu1+b×xu2,” is determined by use of “a” and “b” determined in step S14, S15, and the coordinates of the upper left point of the window are determined on the basis of the center of the stereoscopic image.

Finally, processing is completed by means of displaying a window and a stereoscopic image at the position determined in step S16 (step S17).

Although the case where the perpendicular lenticular lens is used for the stereoscopic image display unit 5 has been described, a case where a tilted lenticular lens is used for the stereoscopic image display unit 5 will be described briefly.

In the case of the 16-parallax stereoscopic image display unit 5 consisting of a tilted lenticular lens, when an image is horizontally displaced by the second shift pitch, the viewing zone is displaced by four parallaxes. However, when the image is vertically displaced by the second shift pitch, the viewing zone is moved by one parallax. In the case of the perpendicular lenticular lens, even when the image is moved vertically, the viewing zone does not move horizontally. Hence, the essential requirement is to take into consideration horizontal position adjustment. However, in the case of the tilted lenticular lens, the viewing zone can be controlled in a more detailed manner by addition of vertical adjustment. In any event, the case of the tilted lenticular lens is identical with the case of the perpendicular lenticular lens in terms of the processes of determining the distance between the center of the stereoscopic image and the center of the display device; determining an appropriate extent to which the viewing zone is to be displaced; and determining an optimal position, which is a combination of the first shift pitch and the second shift pitch, in accordance with the result of determination.

A technique for computing the first shift pitch and the second shift pitch corresponding to various stereoscopic display units 5 will now be described. There will now be described a computing technique for the case of N-parallax stereoscopic image display unit 5 for the case of the perpendicular lenticular lens and the case of the tilted lenticular lens.

First, the arrangement of the color filters in the image display element 51 of the stereoscopic image display unit 5 affects the second shift pitch that is the minimum shift pitch at which color information remains uncollapsed. The RGB color filters are usually arranged into a stripe pattern in the vertical direction. In the case of the tilted lenticular lens, the color filters are arranged in the same layout as in the stripe pattern. In the case of the stereoscopic image display device of the perpendicular lenticular lens, as shown in FIG. 3, the filters of the same color are not arranged vertically, but the same color is repeated every three pixels. Consequently, in the case of the perpendicular lenticular lens, the viewing zone can be moved only three pixel units in the vertical direction. However, in the case of the horizontal and tilted lenticular lens, color information remains uncollapsed. Hence, the viewing zone can be moved on a per-pixel-unit basis.

The first shift pitch, which is the minimum shift pitch and does not induce a change in the direction of the viewing zone, will now be described. In the case of the perpendicular lenticular lens, one element image is formed from N horizontal sub-pixels, which correspond to N/3 pixels. Accordingly, when movement is performed for N/3 pixels, the direction of the viewing zone remains unchanged. In the case of a tilted lenticular lens; e.g., a 16-parallax lenticular lens, 4×4 pixels constitute the unit of an element image. 16 pixels=48 sub-pixels are appropriately distributed in 16 directions. Similarly, in the case of 25 parallaxes, 5×5 pixels correspond to an element image unit. Accordingly, in the case of 16 parallaxes, movement is performed in the unit of four pixels in both the vertical and horizontal directions, whereby the direction of the viewing zone remains unchanged. In the case of 25 parallaxes, movement is performed in five pixel units in both the horizontal and vertical directions, so that the viewing zone remains unchanged.

Consequently, in the case of the N-parallax perpendicular lenticular lens,
the first shift pitch is (N/3, 3), and
the second shift pitch is (1, 3).
Meanwhile, in the case of the N-parallax tilted lenticular lens,
the first shift pitch is (\sqrt{N},\sqrt{N}), and
the second shift pitch is (1, 1).

According to the present embodiment, contents of the window—the graphical user interface of the OS—can be displayed as a stereoscopic image. The graphical user interface of the OS is expressed by a combination of image elements, such as various icons, fonts, or desktop screens. Fonts are text information, but one type of image expressed in dots when being displayed on the screen. Therefore, the fonts are considered as one of image elements. These image elements are prepared as images which can be displayed stereoscopically, and the thus-prepared images are arranged, so that a stereoscopically-displayed screen configuration can be formed. At that time, a small image; e.g., an icon, can be stereoscopically displayed. However, since the image is small, control of the direction of the viewing zone becomes important. When the icon is placed at the end, the icon is preferably automatically adjusted in the second shift pitch such that the viewing zone is oriented toward the observer. According to the present embodiment, when the icon is moved, the position of the icon is automatically adjusted, so that the viewing zone can be oriented toward the position of the observer. Although some OSs have the function of automatically aligning icons, alignment is performed in consideration of control of the viewing zone. Such a function of automatically controlling a position is appropriately incorporated into the OS. According to the user, the standard position of the face (particularly the distance between the face and the display device) changes. In such a case, the position of the face, which is a premise, can be changed. In some cases, the position of the head is monitored at all times by use of a camera or the like, so that the viewing zone suitable for that position can be dynamically adjusted. Thus, there can be embodied such an environment that a desktop screen is deeply recessed and a stereoscopic icon is displayed so as to pop up from the desktop face; and such that operation is performed by use of a stereoscopic mouse cursor. All stereoscopic images displayed on the screen are appropriately stereoscopically viewed from the position of the observer.

According to the embodiment described above, upon receipt of a command to move a stereoscopic image displayed on the stereoscopic image display unit, the movement position of the stereoscopic image determined by the received movement command is corrected to a position where the direction of the viewing zone of the stereoscopic image remains unchanged. Thereby, the stereoscopic image display portion can be moved while the direction of the viewing zone is oriented toward the observer at all times. As a result, the stereoscopic image included in the window smaller than the entire display device is moved while the direction of the viewing zone is maintained, or the stereoscopic image can be controlled such that the direction of the viewing zone becomes appropriate depending on the display position. Thus, control can be performed such that an appropriate stereoscopic image is displayed.

As described with reference to the embodiments, there is provided a stereoscopic image display unit that controls, upon receipt of a command to move the stereoscopic image displayed on a stereoscopic image display unit, a movement position of a stereoscopic image determined by a received movement command such that an appropriate stereoscopic image is displayed.

The foregoing description of the embodiments has been presented for purposes of illustration and description. It is not intended to be exhaustive or to limit the invention to the precise form disclosed, and modifications and variations are possible in light of the above teachings or may be acquired from practice of the invention. The embodiment is chosen and described in order to explain the principles of the invention and its practical application program to enable one skilled in the art to utilize the invention in various embodiments and with various modifications as are suited to the particular use contemplated. It is intended that the scope of the invention be defined by the claims appended hereto, and their equivalents.

What is claimed is:

1. A stereoscopic image display device comprising:
a stereoscopic image display unit that displays a stereoscopic image, and includes:
an image display element that is arranged with a plurality of color pixels; and
a beam direction limitation element that is provided on the image display element and limits a direction of a beam exiting from the image display element;
a movement command reception unit that receives a command to move the stereoscopic image displayed on the stereoscopic image display unit to a movement position; and
a display position correction unit that corrects the movement position that is determined by the command received by the movement command reception unit, to a position where color information of the stereoscopic image remains uncollapsed.

2. The device according to claim 1, wherein the display position correction unit includes a viewing zone direction correction unit that corrects the movement position of the stereoscopic image determined by the command received by the movement command reception unit, to a position where the direction of a viewing zone of the stereoscopic image remains unchanged.

3. The device according to claim 1, wherein the display position correction unit corrects the movement position to a position where color information of the stereoscopic image remains uncollapsed, and where closest to the movement position that is determined by the command received by the movement command reception unit, by referring to a first minimum shift pitch.

4. The device according to claim 2, wherein the viewing zone direction correction unit corrects the movement position of the stereoscopic image in steps of a second minimum shift pitch that prevents inducement of change in the direction of the viewing zone of the stereoscopic image to allow a center of the viewing zone, which is a center of a beam direction at a center position of the stereoscopic image corrected by the display correction unit, passes by a position closest to an observation position.

5. The device according to claim 1, wherein the display position correction unit includes a viewing zone direction correction unit that corrects the movement position of the stereoscopic image determined by the command received by the movement command reception unit, to a position where the direction of a viewing zone of the stereoscopic image remains unchanged,
wherein the display position correction unit corrects the movement position to a position where color information of the stereoscopic image remains uncollapsed, and where closest to the movement position that is determined by the command received by the movement command reception unit, by referring to a first minimum shift pitch, and
wherein the viewing zone direction correction unit corrects the movement position of the stereoscopic image in steps of a second minimum shift pitch that prevents inducement of change in the direction of the viewing zone of the stereoscopic image to allow a center of the viewing zone, which is a center of a beam direction at a center position of the stereoscopic image corrected by the display correction unit, passes by a position closest to an observation position.

6. The device according to claim 5, wherein the stereoscopic image display unit is configured to be replaceable with one of a plurality of stereoscopic image display units having characteristics different from one another.

7. The device according to claim 6, further comprising:
a shift pitch storage unit that stores the first minimum shift pitch and the second minimum shift pitch for each of the plurality of stereoscopic image display units; and
a shift pitch switching unit that switches the use of one or none of the first minimum shift pitch and the second minimum shift pitch stored in the shift pitch storage unit.

8. The device according to claim 4, further comprising a head position detection unit that detects a position of a head of an observer,
wherein the viewing zone direction correction unit uses the position detected by the head position detection unit as the observation position.

9. The device according to claim 5, wherein the image display element is provided with RGB color filters that are vertically arranged in a stripe pattern, and
wherein the beam direction limitation element is provided with a perpendicular lenticular lens having parallax of N pixels,
wherein the first minimum shift pitch is configured to be (1, 3) pixels in X and Y directions, and
wherein the second minimum shift pitch is configured Lo be (N/3, 3) pixels in X and Y directions.

10. The device according to claim 5, wherein the image display element is provided with RGB color filters that are vertically arranged in a stripe pattern, and
wherein the beam direction limitation element is provided with a tilted lenticular lens having parallax of N pixels,
wherein the first minimum shift pitch is configured to be (1, 1) pixels in X and Y directions, and
wherein the second minimum shift pitch is configured to be (\sqrt{N},\sqrt{N}) pixels in X and Y directions.

11. A device comprising:
a stereoscopic image display unit that displays a stereoscopic image, and includes:
an image display element that is arranged with a plurality of color pixels; and
a beam direction limitation element that is provided on the image display element and limits a direction of a beam exiting from the image display element;
a movement command reception unit that receives a command to move the stereoscopic image displayed on the stereoscopic image display unit; and
a viewing zone direction correction unit that corrects the movement position of the stereoscopic image determined by the command received by the movement command reception unit, to a position where the direction of a viewing zone of the stereoscopic image remains unchanged.

12. The device according to claim 11, wherein the viewing zone direction correction unit corrects the movement position of the stereoscopic image in steps of a minimum shift pitch that prevents inducement of change in the direction of the viewing zone of the stereoscopic image to allow a center of the viewing zone, which is a center of a beam direction at a center position of the stereoscopic image corrected by the display correction unit, passes by a position closest to an observation position.

13. The device according to claim 12, further comprising a head position detection unit that detects a position of a head of an observer,
wherein the viewing zone direction correction unit uses the position detected by the head position detection unit as the observation position.

14. The device according to claim 12, wherein the image display element is provided with RGB color filters that are vertically arranged in a stripe pattern, and
wherein the beam direction limitation element is provided with a perpendicular lenticular lens having parallax of N pixels, and
wherein the minimum shift pitch is configured to be (N/3, 3) pixels in X and Y directions.

15. The device according to claim 12, wherein the image display element is provided with RGB color filters that are vertically arranged in a stripe pattern, and
wherein the beam direction limitation element is provided with a tilted lenticular lens having parallax of N pixels, and
wherein the minimum shift pitch is configured to be (\sqrt{N},\sqrt{N}) pixels in X and Y directions.

16. A computer-readable program product for causing a computer to control a stereoscopic display device to display a stereoscopic image, the stereoscopic display having a stereoscopic image display unit that displays the stereoscopic image, and includes: an image display element that is arranged with a plurality of color pixels; and a beam direction limitation element that is provided on the image display element and limits a direction of a beam exiting from the image display element, the program product causing the computer to perform procedures comprising:
receiving a command to move the stereoscopic image displayed on the stereoscopic image display unit to a movement position; and
correcting the movement position that is determined by the received command, to a position where color information of the stereoscopic image remains uncollapsed.

17. The program product according to claim 16, causing the computer to perform procedures further comprising correcting the movement position of the stereoscopic image determined by the received command, to a position where the direction of a viewing zone of the stereoscopic image remains unchanged.

18. A computer-readable program product for causing a computer to control a stereoscopic display device to display a stereoscopic image, the stereoscopic display having a stereoscopic image display unit that displays the stereoscopic image, and includes: an image display element that is arranged with a plurality of color pixels; and a beam direction limitation element that is provided on the image display element and limits a direction of a beam exiting from the image display element, the program product causing the computer to perform procedures comprising:
receiving a command to move the stereoscopic image displayed on the stereoscopic image display unit to a movement position;
correcting the movement position that is determined by the received command, to a position where color information of the stereoscopic image remains uncollapsed; and
correcting the movement position of the stereoscopic image determined by the received command, to a position
where the direction of a viewing zone of the stereoscopic image remains unchanged.

19. A method for controlling a stereoscopic display device to display a stereoscopic image, the stereoscopic display having a stereoscopic image display unit that displays the stereoscopic image, and includes: an image display element that is arranged with a plurality of color pixels; and a beam direction limitation element that is provided on the image display element and limits a direction of a beam exiting from the image display element, the method comprising:
receiving a command to move the stereoscopic image displayed on the stereoscopic image display unit to a movement position; and
correcting the movement position that is determined by the received command, to a position where color information of the stereoscopic image remains uncollapsed.

20. The method according to claim 19, further comprising correcting the movement position of the stereoscopic image determined by the received command, to a position where the direction of a viewing zone of the stereoscopic image remains unchanged.

21. A method for controlling a stereoscopic display device to display a stereoscopic image, the stereoscopic display having a stereoscopic image display unit that displays the stereoscopic image, and includes: an image display element that is arranged with a plurality of color pixels; and a beam direction limitation element that is provided on the image display element and limits a direction of a beam exiting from the image display element, the method comprising:
receiving a command to move the stereoscopic image displayed on the stereoscopic image display unit to a movement position;
correcting the movement position that is determined by the received command, to a position where color information of the stereoscopic image remains uncollapsed; and
correcting the movement position of the stereoscopic image determined by the received command, to a position
where the direction of a viewing zone of the stereoscopic image remains unchanged.
